(19) United States
(12) Patent Application Publication
(10) Pub. No.: US 2007/0223171 A1
(43) Pub. Date: Sep. 27, 2007

(54) Protector Device with Improved Capacity to Break Follow Current

(76) Inventors: Lafon Guy, Bagneres de Bigorre (FR); Herve Lindeperg, Lyon (FR)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 10/596,840

(22) PCT Filed: Dec. 30, 2004
(86) PCT No.: PCT/FR04/03415

§ 371 Date: Jan. 26, 2007

(30) Foreign Application Priority Data
Dec. 30, 2003 (FR) 0315576

(51) Int. Cl. H01T 1/16

(52) U.S. Cl. 361/126

(57) ABSTRACT

A device (1) to protect electrical equipment against transient overvoltages, comprising (i) a spark gap having an intrinsic follow current interrupting capacity and (ii) an element (5) for improving the follow current interrupting power, which co-operates with the spark gap (2) such that the resulting follow current interrupting capacity of the protective device (1) is essentially greater than the aforementioned intrinsic capacity. When the equipment has a suspected short-circuit current that exceeds the intrinsic interrupting capacity of the spark gap (2), element (5) comprises a means (6) for limiting the intensity of the electric current that can pass through the spark gap (2), said limiting means (6) being specifically designed and mounted in relation to the spark gap (2) in order to limit the intensity of the follow current, such that the follow current can be interrupted thanks to the intrinsic follow current interrupting capacity of the spark gap (2).

### PRIORITY CLAIM

This patent application is the U.S. National Phase of International Application No. PCT/FR2004/003415, having an International Filing Date of Dec. 30, 2004, which claims priority to France Patent Application No. 0315576, filed Dec. 30, 2003, the disclosures of which are incorporated herein by reference in their entirety.

### FIELD OF THE INVENTION

The present invention relates to the general technical field of devices for protecting electrical equipment or installations such as electrical apparatuses, circuits, or distribution networks, against possibly brief disturbances to their electrical power supply.

The present invention relates more particularly to a device for protecting electrical equipment against voltage disturbances such as surges, in particular those due to lightning.

The present invention relates to a protector device for protecting electrical equipment against transient surges, the device comprising firstly a spark gap presenting intrinsic capacity to break follow current and secondly an improvement member for improving the follow current breaking power, which member co-operates with the spark gap in such a manner that the protector device presents resultant follow current breaking capacity that is significantly greater than said intrinsic capacity.

The invention also relates to a method of protecting electrical equipment against transient surges in which the electrical equipment is connected to a protector device comprising firstly a spark gap presenting intrinsic capacity to break follow current and secondly an improvement member for improving the follow current breaking power, which member co-operates with the spark gap in such a manner that the device presents resultant follow current breaking capacity that is significantly greater than said intrinsic capacity.

Finally, the invention relates to the use of limiter means for limiting the magnitude of electric current as an improvement member for improving the follow current breaking power of a protector device for protecting electrical equipment against transient surges, said device comprising a spark gap presenting an intrinsic capacity to break follow current, the improvement member for improving follow current breaking power co-operating with the spark gap so that the protector device presents a resultant follow current breaking capacity that is significantly greater than said intrinsic capacity.

### BACKGROUND OF THE INVENTION

Devices for protecting electrical equipment against surges, in particular transient surges, are known and in widespread use.

Such devices are sometimes referred to as “surge arrestors” or as “lightning arrestors”, and they serve to carry lightning current to ground and possibly also to limit the voltage peaks of the induced surges to levels that can be withstood by the equipment connected downstream from a protection device.

Known lightning arrestors can be based on a variety of technologies, depending on the nature of the active protection element used.

In particular, lightning arrestors are known that use a spark gap, i.e., that have as their active protection element a device comprising two electrodes facing each other, one being electrically connected to the phase for protection while the other is electrically connected to ground. The electrodes are separated by an insulating zone, e.g., constituted by air or gas or a dielectric body. When a surge generated by the arrival of lightning current reaches a predetermined level, an electric arc is struck and becomes established between the electrodes, thereby creating a short-circuit for carrying the lightning current to ground, and as a result protecting equipment connected downstream from the lightning arrestor.

Known spark gap lightning arrestors nevertheless present a major drawback associated with an electric arc becoming established between their electrodes. Once the lightning current has been carried to ground by said electric arc, the arc does not extinguish spontaneously and thus continues to carry current, known as “follow current”, that is taken from the installation for protection.

The follow current must be interrupted in order to reestablish normal operation of the installation, and in particular in order to avoid any uncontrolled heating of the lightning arrestor.

The follow current could naturally be interrupted by a general interrupter member of the network such as a circuit breaker. Nevertheless, the use of such a general interrupter member for breaking the follow current puts the network out of operation.

It is therefore preferable for the lightning arrestor itself to be capable of breaking the follow current without causing the general interrupter member to open.

By their very construction, known spark gaps present a “natural” capacity for breaking follow current. This intrinsic capacity for breaking follow current corresponds to the maximum magnitude of current that the spark gap can extinguish itself, due to its own characteristics alone.

Nevertheless, this “natural” capacity to break current is generally not sufficient to handle real operating conditions which can involve follow currents of relatively large magnitudes.

That is why various means have been used in the prior art for increasing the break capacity of spark gaps. By way of example, known spark gaps have thus been provided with interrupter chambers, enabling the electric arc to be subdivided so as to make it easier to extinguish, or indeed with air circulation systems serving to achieve the same function. However, such additional means for increasing break capacity are generally extremely difficult to implement, in particular because they can have a strong negative influence on the capacity to carry lightning current, even though this capacity to carry lightning current is specifically the primary function of a spark gap.

In addition to the fact that such means for improving break capacity tend to degrade the current-carrying capacity of the spark gap, they are also generally expensive, bulky, and difficult to fabricate.

### SUMMARY OF THE INVENTION

A feature of the present invention is to provide a remedy to the various above-mentioned drawbacks of the prior art, and to provide a novel device for protecting electrical equipment against transient surges, which device is simple in design and presents improved capacity to break follow current, while conserving good capacity for carrying lightning current.

Another feature of the invention is to provide a novel device for protecting electrical equipment against transient surges that is of construction that is particularly simple and inexpensive.

Another feature of the invention is to provide a novel device for protecting electrical equipment against transient surges presenting an excellent compromise between voltage protection and capacity for breaking follow current.

Another feature of the invention is to provide a novel device for protecting electrical equipment against transient surges implementing standard electrical components.

Another feature of the invention is to provide a novel device for protecting electrical equipment against transient surges that is compact and very easy and quick to fabricate.

Another feature of the invention is to provide a novel method of protecting electrical equipment against transient surges that is particularly effective and reliable.

Another feature of the invention is to provide a novel method of protecting electrical equipment against transient surges that is particularly simple to implement.

Another feature of the invention is to provide a novel method of protecting electrical equipment against transient surges that is inexpensive.

Another feature of the invention is to provide a novel use of means for limiting the magnitude of an electric current enabling the protection of electrical equipment against transient surges to be improved.

The features given to the invention are achieved with the help of a protector device for protecting electrical equipment against transient surges, the device comprising firstly a spark gap presenting intrinsic capacity to break follow current and secondly an improvement member for improving the follow current breaking power, which member co-operates with the spark gap in such a manner that the protector device presents resultant follow current breaking capacity that is significantly greater than said intrinsic capacity, the device being characterized in that for equipment presenting an assumed short-circuit current that exceeds said intrinsic breaking capacity of the spark gap, the improvement member comprises limiter means for limiting the magnitude of the electrical current passing through the spark gap, said limiter means being specifically designed and connected relative to the spark gap to limit the magnitude of the follow current in such a manner that said follow current can be interrupted by the intrinsic follow current breaking capacity of the spark gap alone.

The features given to the invention are also achieved with the help of a method of protecting electrical equipment against transient surges in which the electrical equipment is connected to a protector device comprising firstly a spark gap presenting intrinsic capacity to break follow current and secondly an improvement member for improving the follow current breaking power, which member co-operates with the spark gap in such a manner that the device presents resultant follow current breaking capacity that is significantly greater than said intrinsic capacity, the method being characterized in that for equipment presenting an assumed short-circuit current that exceeds said intrinsic breaking capacity of the spark gap, the improvement member comprises limiter means for limiting the magnitude of the electrical current passing through the spark gap, said limiter means being specifically designed and connected relative to the spark gap to limit the magnitude of the follow current in such a manner that said follow current can be interrupted by the intrinsic follow current breaking capacity of the spark gap alone.

The features given to the invention are also achieved with the help of the use of limiter means for limiting the magnitude of electric current as an improvement member for improving the follow current breaking power of a protector device for protecting electrical equipment against transient surges, said device comprising a spark gap presenting an intrinsic capacity to break follow current, the improvement member for improving follow current breaking power co-operating with the spark gap so that the protector device presents a resultant follow current breaking capacity that is significantly greater than said intrinsic capacity, the use being characterized in that for equipment presenting an assumed short-circuit current that exceeds said intrinsic breaking capacity of the spark gap, the limiter means is specifically designed and connected relative to the spark gap to limit the magnitude of the follow current passing through the spark gap in such a manner that said follow current can be interrupted by the intrinsic follow current breaking capacity of the spark gap alone.

### BRIEF DESCRIPTION OF THE DRAWINGS

Other features and advantages of the invention appear in greater detail on reading the following description with reference to the accompanying drawing given as non-limiting illustrative examples and in which:

FIG. 1 is a diagrammatic view of a first variant exemplary embodiment of a protector device in accordance with the invention; and

FIG. 2 is a diagrammatic view of a second variant exemplary embodiment of a protector device in accordance with the invention.

### DESCRIPTION OF THE INVENTION

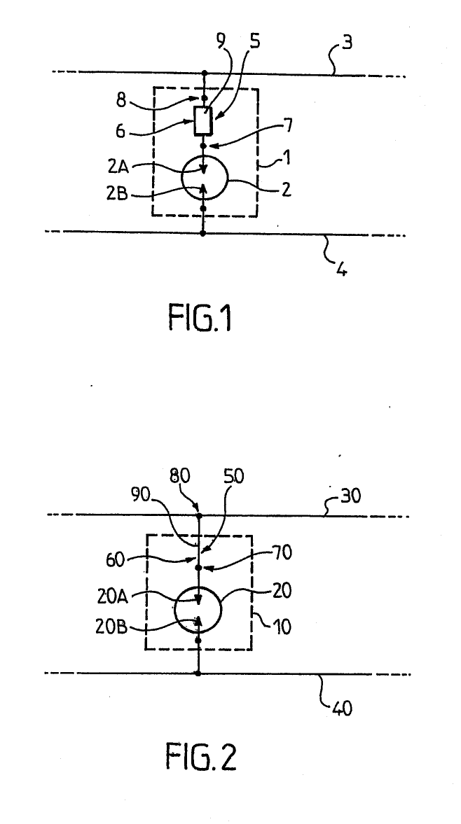

FIGS. 1 and 2 show a device 1, 10 for protecting electrical equipment against surges, in particular against transient voltage surges of the type generated by a lightning strike.

The term electrical equipment is used herein to mean any type of apparatus, instrument, installation, network, electrical circuit or telecommunications circuit that might be subjected to electrical power supply uncertainties from the voltage point of view, and in particular to surges due to lightning.

As is well known to the person skilled in the art, the electrical equipment for protection presents an assumed short-circuit current that corresponds to a given electrical current value that is known (or that can be known) to the person skilled in the art.

The surge protector device 1, 10 in accordance with the invention advantageously constitutes a lightning arrestor.

In accordance with the invention, the device 1, 10 comprises a lightning arrestor cell constituted specifically by a spark gap 2, 20. The spark gap 2, 20 implemented in the context of the invention can be of any type known to the person skilled in the art, and for example can be constituted by an air-filled or a gas-filled spark gap. The invention is absolutely not limited to any particular type of spark gap, and any type of spark gap well known to the person skilled in the art could be used.

In conventional manner, the spark gap 2, 20 comprises a first electrode 2A, 20A electrically connected to the phase 3, 30 for protection, together with a second electrode 2B, 20B for connecting electrically to ground 4, 40. Without going beyond the ambit of the invention, it is also possible to envisage that, instead of being connected in parallel between a phase 3, 30 and ground 4, 40, the spark gap 2, 20 could be connected between neutral and ground, or between a phase and neutral, or indeed between two phases (differential protection).

Preferably, the spark gap 2, 20 constitutes the single active component of the device 1, 10, it being understood that without going beyond the ambit of the invention it is possible to envisage said spark gap 2, 20 being associated with other non-linear components, whether or not they are constituted by spark gaps.

In conventional manner, the spark gap 2, 20 presents an intrinsic capacity to break follow current.

This intrinsic capacity to break follow current corresponds to the magnitude to the maximum current the spark gap 2, 20 is capable of breaking on its own, i.e., solely because of its construction of two electrodes separated by an insulating zone, and without help from additional devices. This “natural” break capacity results in particular from the relative shapes of the various elements making up the spark gap 2, 20, the materials selected for making said elements, and the dimensioning of said elements.

In accordance with the invention, the protector device 1, 10 also includes an improvement member 5, 50 for improving its follow current breaking power, said member 5, 50 co-operating with the spark gap 2, 20 in such a manner that the device 1, 10 presents a resulting capacity for breaking follow current that is significantly greater than the intrinsic capacity of the spark gap 2, 20 on its own for breaking follow current.

The improvement member 5, 50 thus enables the magnitude of follow current that the device 1, 10 is capable of breaking after it has carried lightning current to be increased compared with a device comprising the spark gap 2, 20 on its own.

In accordance with an important characteristic of the invention, the improvement member 5, 50 comprises limiter means 6, 60 for limiting the magnitude of the electric current passing through the spark gap 2, 20, and in particular for limiting the magnitude of the follow current.

The term “limit” is used herein to specify an ability to oppose the passage of electric current that leads to the magnitude of the electric current being decreased so that its value is less than the value that it would have in the absence of the limiter means 6, 60.

Thus, the follow current that is “perceived” by the lightning arrestor 1, 10 is smaller than the assumed short-circuit current of the installation for protection, because of the presence of the limiter means 6, 60. This technical disposition thus allows a spark gap lightning arrestor to be installed in an installation whose assumed short-circuit current exceeds the intrinsic capacity of the spark gap 2, 20 to break follow current.

The assembly constituted by the spark gap 2, 20 and the limiter means 6, 60 thus behaves like a lightning arrestor with high breaking capacity, but without that necessarily requiring the implementation of an interrupter chamber or of any other conventional interrupter means (plastics material degassing hydrogen, air circulation).

The general principle of the invention thus relies on implementing a “decoy” which artificially reduces the magnitude of the follow current carried by the spark gap 2, 20 so that said current can be interrupted merely by the intrinsic follow current-breaking capacity of the spark gap 2, 20.

The improvement member 5, 50 is thus specifically designed and connected relative to the spark gap 2, 20 so as to limit the magnitude of the follow current to a value that is lower than the assumed short-circuit current of the installation for protection, said value being compatible with the spark gap's own extinguishing power.

In other words, the invention advantageously consists in:

firstly protecting the equipment by means of a spark gap 2, 20 presenting intrinsic capacity to break follow current that is less than the presumed short-circuit current of the installation; this means that although the spark gap presents good capacity for carrying the lightning current, it is not capable on its own of breaking the follow current since its intrinsic breaking capacity is too small compared with the follow current that is likely to be taken by the equipment; and

secondly in remedying the above-mentioned insufficient follow current breaking capacity by functionally associating the spark gap 2, 20 with limiter means 6, 60 for limiting the magnitude of the electric current passing through the spark gap so that after a transient surge, the spark gap does not convey the short-circuit current of the equipment, but a current that is smaller than said short-circuit current, and that is sufficiently small for it to be possible for the spark gap to break it exclusively on its own; this means that the limiter means 6, 60 is designed (and in particular dimensioned) as a function of the presumed short-circuit current of the equipment so that the follow current passing through the spark gap is less than the intrinsic breaking capacity of the spark gap.

The invention thus makes it possible in simple and inexpensive manner to overcome the conflict inherent to any spark gap between high capacity to carry lightning current and high capacity to break follow current. By selecting a spark gap of low follow current breaking capacity, i.e., preferably less than the assumed short-circuit current of the equipment for protection, the invention makes it possible in return to benefit from high capacity for carrying current, with the low breaking capacity of the spark gap being corrected by implementing the limiter means.

Advantageously, the improvement member 5, 50 comprises as its means for limiting current a resistive element 9, 90, preferably a linear resistive element. This resistive element 9, 90 is preferably connected in series with the spark gap 2, 20.

The term “resistive” should be understood in its broadest sense, i.e., it refers both to resistive behavior when fed with direct current (DC), and to impedance behavior when fed with alternating current (AC).

More particularly, and as shown in FIGS. 1 and 2, the resistive element 9, 90 has a first terminal 7, 70 electrically connected to the first electrodes 2A, 20A of the spark gap 2, 20, and a second terminal 8, 80, electrically connected to the phase 3, 30 for protection. The subassembly constituted by the series connection of the resistive element 9, 90 and the spark gap 2, 20 is thus connected in parallel between the phase 3, 30 and ground 4, 40.

Advantageously, the resistive element 9, 90 presents substantially no self-inductance, i.e., it generates substantially no inductance effect, or it generates induction effects that are as small as possible or negligible compared with the selected resistance value.

In other words, for a given resistance value (in ohms) for the element 9, 90, it should be shaped so as to significantly limit any induction effects. To this end, the resistive element 9, 90 is preferably solid and compact and does not form a loop or a winding or a helix.

This technical disposition enables the device 1, 10 in accordance with the invention to avoid generating any additional surge when passing lightning current. As a result, the level of voltage protection provided by the device 1, 10 is not degraded compared with that of a device comprising the spark gap 2, 20 on its own without the improvement member 5, 50. The substantially non-inductive connection of the resistive element 9, 90 in series with the spark gap 2, 20 thus makes it possible in very simple manner to significantly increase the follow current breaking capacity of the device 1, 10 compared with a device comprising the spark gap 2, 20 on its own, but without that having a negative influence on the capacity of the spark gap 2, 20 to carry lightning current, as would be the case for example with a conventional interrupter chamber.

In independent manner, the invention also relates to a protector device 1, 10 for protecting electrical equipment against transient surges and comprising firstly a spark gap 2, 20 presenting an intrinsic capacity to break follow current, and secondly an improvement member 5, 50 for improving follow current breaking power, which member co-operates with the spark gap 2, 20 so that the device 1, 10 presents a resultant capacity for breaking follow current that is substantially greater than said intrinsic capacity, said improvement member 5, 50 comprising limiter means 6, 60 for limiting the magnitude of the electric current passing through the spark gap 2, 20, said limiter means 6, 60 itself comprising a resistive element 9, 90 connected in series with the spark gap 2, 20, said resistive element being of a substantially non-inductive nature.

In the first variant exemplary embodiment, shown in FIG. 1, the resistive element is advantageously formed by an electrical resistor 9, i.e., by a single linear electrical component that can be identified as such and that is characterized essentially by its ability to limit the current flowing in a circuit in a manner that is substantially constant, predetermined, and known.

In the variant shown in FIG. 2, the protector device 1, 10 in accordance with the invention comprises electrical connection means of the spark gap 2, 20 for connecting it to the electrical equipment for protection 3, 30, 4, 40, said connection means directly constituting the resistive element 90, thereby eliminating any need to connect an additional distinct electrical component.

In particular, the material(s) from which the connection means are made, and also the dimensions of said connection means (in particular in terms of section) are selected to that the connection means perform the function of limiting the magnitude of the electrical current that is looked for in the context of the present invention.

Preferably, the connection element for connecting the first electrode 20A to the phase for protection 30 is designed to act exclusively as the protection member 50.

The Applicant has discovered that a low-resistance resistive element suffices to obtain a significant technical effect. By way of example, for an installation powered at 230 volts (V) and 25 kiloamps (kA), an appreciable result can be obtained with a resistive element presenting resistance of a few milliohms (mΩ), e.g., lying in the range 10 mΩ to 50 mΩ.

More generally, the resistive element should be selected as a function of the assumed short-circuit current of the installation, and of the intrinsic capacity of the intended spark gap for breaking follow current.

Advantageously, the improvement member 5, 50 is constituted exclusively by the resistive element 9, 90, regardless of whether it is based on components presenting electrical resistance or based directly on connection means specifically designed for this purpose.

The effect of improving breaking power is thus obtained substantially exclusively by the spark gap 2, 20 being connected in series with a resistive element 9, 90.

Nevertheless, without going beyond the ambit of the invention, it is entirely possible to envisage the improvement member 5, 50 further comprising, in addition to the limiter means 6, 60, conventional means of the interrupter chamber kind, for example. Under such circumstances, the intrinsic capacity for breaking follow current will correspond to the breaking capacity of the subassembly constituted by the spark gap 2, 20 and said conventional means whether of the interrupter chamber kind or of some other kind. The limiter means 6, 60 serve to further improve that intrinsic capacity, even if it is already greater than the capacity of a spark gap 2, 20 “alone”, i.e., without any additional arc-extinguishing means.

The invention also provides a method of improving the follow current breaking capacity of a device 1, 10 for protecting electrical equipment against surges such as a lightning arrestor, said device including a spark gap 2, 20.

According to an important characteristic of the invention, the method in accordance with the invention comprises an improvement step in which the device 1, 10 is provided with limiter means 6, 60 for limiting the magnitude of the electric current passing through the spark gap 2, 20, and in particular the follow current that occurs after carrying lightning current.

During the improvement step, a resistive element 9, 90 is advantageously connected in series with the spark gap 2, 20.

In a first variant implementation of the method in accordance with the invention, the resistive element 9 is formed by an electrical resistor, as described above.

In a second variant, the method comprises a step in which the spark gap 2, 20 is connected to the equipment for protection by electrical connection means, said connection means being specifically designed to form directly the resistive element 90, again as described above.

The method in accordance with the invention thus makes it possible in simple and rapid manner to improve the breaking capacity of any spark gap lightning arrestor in existence on the market, merely by adding resistive means selected as a function of the intrinsic breaking capacity of the spark gap, and of the assumed short-circuit current of the installation to be protected.

The invention also provides a method of protecting electrical equipment against transient surges in which the electrical equipment is functionally connected to a protector device 1, 10 comprising firstly a spark gap 2, 20 presenting an intrinsic capacity for breaking follow current, and secondly an improvement member 5, 50 for improving the follow current breaking power, which member co-operates with the spark gap 2, 20 in such a manner that the device 1, 10 presents a resulting capacity for breaking follow current that is substantially greater than said intrinsic capacity.

In this method, the equipment presents an assumed short-circuit current which exceeds the intrinsic breaking capacity of the spark gap 2, 20. In other words, the intrinsic breaking capacity of the spark gap 2, 20 is perceptibly lower than the assumed short-circuit current of the equipment for protection.

In accordance with the protection method of the invention, the improvement member 5, 50 comprises limiter means 6, 60 for limiting the magnitude of the electric current passing through the spark gap 2, 20, said limiter means 6, 60 being specifically designed and connected relative to the spark gap 2, 20 to limit the magnitude of the follow current so that said follow current can be interrupted solely by the intrinsic capacity of the spark gap 2, 20 to break follow current.

Advantageously, the improvement member 5, 50 comprises as its limiter means a resistive element 9, 90 connected in series with the spark gap 2, 20.

The resistive element 9, 90 is preferably constituted by an electrical resistor 9.

Advantageously, the spark gap 2, 20 connected to the equipment by electrical connection means, said electrical connection means forming the resistive element 90.

Finally, the invention also relates to the use of limiter means of the electrical resistor kind for limiting the magnitude of an electric current, as an improvement member for improving the follow current breaking power of a device, of the lightning arrestor kind, for protecting electrical equipment against surges, which device comprises a spark gap presenting intrinsic capacity to break follow current, such that said device presents a resulting capacity for breaking follow current that is greater than said intrinsic capacity.

More precisely, the invention relates to the use of limiter means 6, 60 for limiting the magnitude of electric current as an improvement member 5, 50 for improving the follow current breaking power of a device 1, 10 for protecting electrical equipment against transient surges, said device 1, 10 comprising a spark gap 2, 20 presenting intrinsic capacity for breaking follow current, the improvement member 5, 50 for improving the follow current breaking power co-operating with the spark gap 2, 20 in such a manner that the protection device 1, 10 presents resultant follow current breaking capacity that is significantly greater than said intrinsic capacity, the use being characterized in that for equipment presenting an assumed short-circuit current that exceeds said intrinsic breaking capacity of the spark gap 2, 20, the limiter means 6, 60 is specifically designed and connected relative to the spark gap 2, 20 to limit the magnitude of the follow current passing through the spark gap 2, 20 in such a manner the said follow current can be interrupted by the intrinsic follow current breaking capacity of the spark gap 2, 20 alone.

The invention thus seeks in particular to provide a novel use of known electrical resistance components as components for increasing the follow current breaking capacity of known standard spark gaps.

Finally, the invention makes it possible in simple but significant manner to improve the breaking power of any known device subject to the phenomenon of follow current, while providing good protection against transient surges.

One industrial application of the invention lies in the design, manufacture, and use of protector devices for providing protection against transient surges.

All patents, applications and publications referred to herein are incorporated by reference in their entirety.

1. A protector device for protecting electrical equipment against transient surges, the device comprising:
a. a spark gap presenting intrinsic capacity to break follow current; and
b. an improvement member for improving the follow current breaking power
wherein the member co-operates with the spark gap such that the protector device presents resultant follow current breaking capacity that is significantly greater than said intrinsic capacity, wherein the device for equipment presenting an assumed short-circuit current that exceeds said intrinsic breaking capacity of the spark gap, the improvement member comprises limiter means for limiting the magnitude of the electrical current passing through the spark gap, said limiter means being specifically designed and connected relative to the spark gap to limit the magnitude of the follow current in such a manner that said follow current can be interrupted by the intrinsic follow current breaking capacity of the spark gap alone.

2. The device of claim 1, wherein the improvement member comprises a resistive element connected in series with the spark gap.

3. The device of claim 2, wherein the resistive element presents substantially no self-induction.

4. The device of claim 2, wherein the resistive element is formed by an electrical resistor.

5. The device of claim 2, wherein said device includes an electrical connection means for connecting the spark gap to the electrical equipment, said connection means forming the resistive element.

6. The device of claim 2, wherein the improvement member is constituted exclusively by the resistive element.

7. The device of claim 1, wherein the device constitutes a lightning arrestor.

8. A method of protecting electrical equipment against transient surges in which the electrical equipment is connected to a protector device, comprising:
a. a spark gap presenting intrinsic capacity to break follow current; and
b. an improvement member for improving the follow current breaking power, which member co-operates with the spark gap in such a manner that the device presents resultant follow current breaking capacity that is significantly greater than said intrinsic capacity,
the method being characterized in that for equipment presenting an assumed short-circuit current that exceeds said intrinsic breaking capacity of the spark gap, the improvement member comprises limiter means for limiting the magnitude of the electrical current passing through the spark gap, said limiter means being specifically designed and connected relative to the spark gap to limit the magnitude of the follow current in such a manner that said follow current can be interrupted by the intrinsic follow current breaking capacity of the spark gap alone.

9. The method of claim 8, wherein the improvement member comprises a resistive element connected in series with the spark gap.

10. The method of claim 9, wherein the resistive element is formed by an electrical resistor.

11. The method of claim 9, wherein the spark gap is connected to the equipment by electrical connection means, said connection means forming the resistive element.

12. The use of limiter means for limiting the magnitude of electric current as an improvement member for improving the follow current breaking power of a protector device for protecting electrical equipment against transient surges, said device comprising a spark gap presenting an intrinsic capacity to break follow current, the improvement member for improving follow current breaking power co-operating with the spark gap so that the protector device presents a resultant follow current breaking capacity that is significantly greater than said intrinsic capacity, the use being characterized in that for equipment presenting an assumed short-circuit current that exceeds said intrinsic breaking capacity of the spark gap, the limiter means is specifically designed and connected relative to the spark gap to limit the magnitude of the follow current passing through the spark gap in such a manner that said follow current can be interrupted by the intrinsic follow current breaking capacity of the spark gap alone.

13. The device of claim 2, wherein the resistive element is formed by an electrical resistor.

14. The device of claim 2, wherein said device includes an electrical connection means for connecting the spark gap to the electrical equipment, said connection means forming the resistive element.
